(19) United States
(12) Patent Application Publication
(10) Pub. No.: US 2004/0044756 A1
(43) Pub. Date: Mar. 4, 2004

(54) Method and apparatus for providing management access to devices behind a network address translator (NAT)

(75) Inventor: Gerald Johnson, Cataumet, MA (US)

Correspondence Address: VOLPE AND KOENIG, P.C., DEPT. MOT, UNITED PLAZA, SUITE 1600, 30 SOUTH 17TH STREET, PHILADELPHIA, PA, 19103, US

(73) Assignee: General Instrument Corporation, Horsham, PA (US)

(21) Appl. No.: 10/232,096

(22) Filed: Aug. 30, 2002

(51) Int. Cl. G06F 15/173

(52) U.S. Cl. 709/223; 709/238

(57) ABSTRACT

Apparatus and method for providing management capabilities for a range of device types in private address space employing a simple network management protocol (SNMP) proxy agent enabling devices in external space having globally unique addresses to communicate with devices in the private address space.

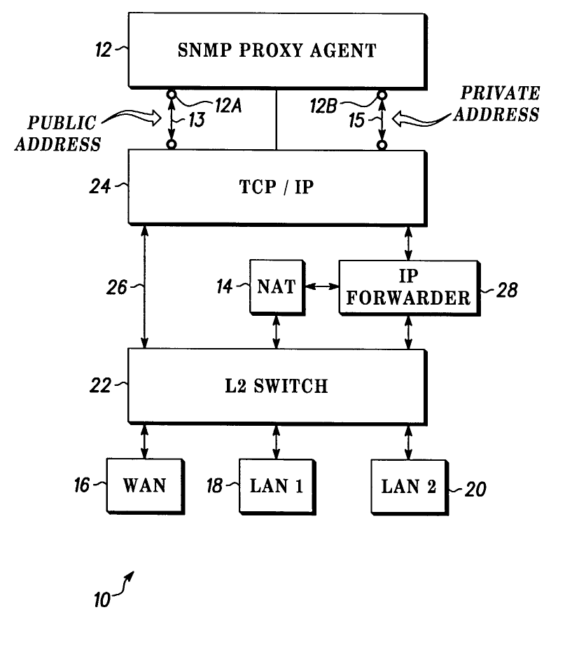

### BACKGROUND

The present invention relates to management of devices on a home network; more particularly, the present invention relates to the capability of managing devices on a home network, wherein utilization of a simple network management protocol (SNMP) proxy agent enables access to both private and public address spaces on each side of a network access translator (NAT).

In applications where a network address translator (NAT) is required in order to communicate with the head end, a NAT does not allow simple network management protocol to be utilized. It is, therefore, desirous to provide a means by which private networks may easily communicate using SNMP.

### SUMMARY

The present invention utilizes a SNMP proxy agent, having access to both private and public address spaces on each side of a NAT, and which provides additional features to a cable operator and further requires no changes in the system standards.

### BRIEF DESCRIPTION OF THE FIGURE

The sole figure of the present application is a block diagram showing the manner in which private and public address spaces are interfaced in accordance with the principles of the present invention.

### DETAILED DESCRIPTION OF THE PREFERRED EMBODIMENT(S)

Making reference to the sole FIGURE of the present application, there is shown therein a system 10, utilizing an SNMP Proxy Agent 12, for providing capabilities around a NAT 14, and which provides a full set of management capabilities for a range of device types in the private address space behind NAT 14.

To accomplish this, an SNMP Proxy Agent 12 is provided, which has access to both private and public addresses on each side of NAT 14. SNMP Proxy Agent 12 has two network interfaces, i.e., a Network Interface 13, for connection to the public address space and a Network Interface 15, for connection to the private address space. The port 12A, on the public side, is used to send and receive SNMP messages to and from a network management system (NMS), not shown for purposes of simplicity, also in the public address space, and typically located at the multimedia systems operator MSO head end or at the network control center.

The port 12B, on the private side, is used to send messages in an arbitrary format to the appropriate devices or objects in the private address space. The management station contacts proxy agent 12, indicating the identity of the foreign device. The proxy agent translates the protocol interactions it received from the management station to interactions supported by the foreign (private) device.

In the system embodiment 10, NAT 14 is not part of the data flow, but is provided in the system to act as a quasi-transparent address translator for end-to-end applications. In the SNMP proxy agent case, transmission control protocol/user datagram protocol (TCP/UDP) connections are terminated, and appropriate addresses that do not need translating are used.

The SNMP proxy agent 12 can use an approach that provides a separate object identifier (OID) for each managed object or device and, thereby, appear to the management system such that each object has an SNMP agent. A private management information base (MIB) is created for each object class.

The System 10 shows a wide area network (WAN) 16, and two local area networks 18 (LAN1) and 20 (LAN2), coupled through L2 switch 22, directly or through the NAT 14 and Internet Protocol (IP) Forwarder 28. Addresses that do not require translation are coupled directly from L2 switch 22 to the proper local area network 18 or 20 (LAN1 or LAN2). Addresses that do require translation are coupled to the proper local area network 18 or 20 (LAN1 or LAN2) through NAT 14 and Internet Protocol Forwarder 28.

What is claimed is:

1. Apparatus for providing management capabilities for a range of device types in private address space, comprising:
a plurality of devices in a private address space;
a network address translator (NAT) for connecting devices in the private address space to an external space having globally unique registered addresses;
a simple network management protocol (SNMP) proxy agent having a first port for interfacing with public addresses and a second port for interfacing with private addresses to enable devices in the private address space to communicate using simple network management protocol.

2. The apparatus of claim 1 wherein the SNMP proxy agent translates received private address messages and forwards them to the device in the public address space.

3. The apparatus of claim 1 wherein the SNMP proxy agent translates received public address messages and forwards them to the device in the private address space.

4. The apparatus of claim 1 wherein devices in the private address space are coupled to the external space by a transmission control protocol/internet protocol (TCP/IP) network.

5. The apparatus of claim 4 wherein devices in the private address space are coupled to the TCP/IP through an L2 switch.

6. The apparatus of claim 4 wherein devices in the private address space are coupled to the TCP/IP through an L2 switch and an Internet Protocol (IP) forwarder.

7. The apparatus of claim 4 wherein the devices in the private address space are coupled to said NAT, said NAT being coupled to the TCP/IP network through an Internet Protocol (IP) forwarder.

8. The apparatus of claim 7 wherein the devices in the private address space are coupled to the NAT by an L2 switch.

9. The apparatus of claim 5 wherein the devices in the private address space are arranged in a wide area network (WAN).

10. The apparatus of claim 5 wherein the devices in the private address space arranged in a local area network (LAN).

11. The apparatus of claim 6 wherein the devices in the private address space are arranged in a wide area network (WAN).

12. The apparatus of claim 6 wherein the devices in the private address space are arranged in a local area network (LAN).

13. The apparatus of claim 7 wherein the devices in the private address space are arranged in a wide area network (WAN).

14. The apparatus of claim 7 wherein the devices in the private address space are arranged in a local area network (LAN).

15. A method for operating a simple network management protocol (SNMP) proxy agent to provide management capabilities for a range of device types in private address space, comprising:
a) receiving a message having a destination address from an external a device in space having globally unique registered addresses;
b) converting the address of the message received at step (a) in accordance with protocol interactions obtained from a network management station to interactions supported by a device in the private space identified by the received address; and
c) transferring the message to the device in the private address space.
